(19) United States
(12) Patent Application Publication
(10) Pub. No.: US 2024/0070500 A1
(43) Pub. Date: Feb. 29, 2024

(54) METHOD AND APPARATUS FOR SIMULATING QUANTUM CIRCUIT

(71) Applicant: BEIJING BAIDU NETCOM SCIENCE TECHNOLOGY CO., LTD., Beijing (CN)

(72) Inventor: Kun Fang, Beijing (CN)

(73) Assignee: BEIJING BAIDU NETCOM SCIENCE TECHNOLOGY CO., LTD., Beijing (CN)

(21) Appl. No.: 17/899,575

(22) Filed: Aug. 30, 2022

(30) Foreign Application Priority Data
Aug. 31, 2021 (CN) 202111015666.0

(51) Int. Cl. G06N 10/20

(52) U.S. Cl. CPC G06N 10/20

(57) ABSTRACT

A method for operating a quantum computer is provided. The method includes: obtaining a quantum gate parameter of each quantum gate in a quantum circuit to be simulated; and generating a sub-measurement mode equivalent to the quantum gate based on the quantum gate parameter. The method further includes combining the sub-measurement mode equivalent to each quantum gate to obtain an overall measurement mode equivalent to the quantum circuit to be simulated as a whole; and sorting an operation order of the operation commands of each sub-measurement mode in the overall measurement mode, thereby obtaining the sorted overall measurement mode as a simulation result. This solution transforms the quantum circuit used for quantum computation into an equivalent measurement mode according to a one-way quantum computer computation model. Direct simulation computation on the quantum circuit can be avoided, and accordingly a simulation operation amount of a classical computer is greatly reduced.

### CROSS REFERENCE TO RELATED APPLICATIONS

This application claims priority to Chinese Patent Application No. 202111015666.0, filed on Aug. 31, 2021, the content of which is hereby incorporated by reference in its entirety for all purposes.

### TECHNICAL FIELD

The present disclosure relates to the field of quantum computation, in particular to a method and apparatus for simulating a quantum circuit, a method and apparatus for quantum computation, an electronic device, a computer storage medium, and a computer program product.

### BACKGROUND

Quantum computation is a novel computation mode that follows the laws of quantum mechanics to control a quantum information unit for computation. A theoretical model of a universal quantum computer is a universal Turing machine reinterpreted by the laws of quantum mechanics. In terms of computational efficiency, due to the existence of quantum mechanical superposition, some known quantum algorithms can process problems faster than traditional general computers.

### SUMMARY

The present disclosure provides a method for simulating a quantum circuit, including: obtaining a quantum gate parameter of each quantum gate in a quantum circuit to be simulated; for each quantum gate in the quantum circuit to be simulated, generating a sub-measurement mode equivalent to the quantum gate based on the quantum gate parameter of the quantum gate, the sub-measurement mode including a plurality of operation commands; combining the sub-measurement mode equivalent to each quantum gate to obtain an overall measurement mode equivalent to the quantum circuit to be simulated as a whole; and sorting an operation order of the plurality of operation commands of each sub-measurement mode in the overall measurement mode according to a preset priority sorting rule, and obtaining the sorted overall measurement mode as a simulation result of the quantum circuit to be simulated.

According to another aspect of the present disclosure, a method for quantum computation is provided, and includes: generating an equivalent quantum circuit based on expected quantum computation, thereby obtaining a quantum circuit to be simulated; performing the above method for simulating the quantum circuit; and performing corresponding operations on a quantum system according to an obtained overall measurement mode to obtain a plurality of measurement values; and determining a computation result of the expected quantum computation according to the plurality of measurement values.

According to another aspect of the present disclosure, an electronic device is provided. The electronic device includes: one or more processors; and a memory storing one or more programs configured to be executed by the one or more processors, the one or more programs including instructions for causing the electronic device to perform operations comprising: obtaining a quantum gate parameter of each quantum gate in a quantum circuit to be simulated; for each quantum gate in the quantum circuit to be simulated, generating a sub-measurement mode equivalent to the quantum gate based on the quantum gate parameter of the quantum gate, the sub-measurement mode comprising a plurality of operation commands; combining the sub-measurement mode equivalent to each quantum gate to obtain an overall measurement mode equivalent to the quantum circuit to be simulated as a whole; and sorting an operation order of the plurality of operation commands of each sub-measurement mode in the overall measurement mode according to a preset priority sorting rule, thereby obtaining a sorted overall measurement mode as a simulation result of the quantum circuit to be simulated.

The methods according to one or more embodiments of the present disclosure transform a quantum circuit for quantum computation into an equivalent measurement mode according to a one-way quantum computer computation model. The quantum system of a quantum computer is operated according to the above equivalent measurement mode so as to make the quantum system evolve according to the equivalent quantum circuit. Therefore, in the case of using a classical computer for quantum computation, the method of the present embodiment is used to avoid direct simulation on the quantum circuit for quantum computation. Instead, the function of the equivalent quantum circuit can be achieved by performing corresponding operations on qubits in the quantum system, so that a simulation operation amount of the classical computer is greatly reduced. In addition, the method also sorts the operation commands of the measurement mode according to the preset priority sorting rule, and optimizes the operation order of the plurality of operation commands, thereby improving the efficiency of simulating the measurement mode.

It should be understood that the content described in this part is not intended to identify key or important features of the embodiments of the present disclosure, nor is it used to limit the scope of the present disclosure. Other features of the present disclosure will be easily understood by the following description.

### BRIEF DESCRIPTION OF THE DRAWINGS

The accompanying drawings exemplarily illustrate embodiments and form part of the description, which, together with the textual description of the description, is used to explain exemplary implementations of the embodiments. The illustrated embodiments are for illustrative purposes only and do not limit the scope of the claims. In all the drawings, the same reference numerals refer to similar but not necessarily identical elements.

FIG. 1 shows a flowchart of a method for simulating a quantum circuit according to an embodiment of the present disclosure;

FIG. 2 shows a schematic diagram of a quantum circuit according to an embodiment of the present disclosure;

FIG. 3 shows a flowchart of a method for generating a sub-measurement mode equivalent to a quantum gate according to an embodiment of the present disclosure;

FIG. 4 shows a flowchart of a method for sorting a plurality of measurement commands in an overall measurement mode according to an embodiment of the present disclosure;

FIG. 5 shows a flowchart of a method for sorting measurement commands according to an operation priority according to an embodiment of the present disclosure;

FIG. 6 shows a flowchart for implementing the methods shown in FIG. 4 and FIG. 5 by using a computer program according to an embodiment of the present disclosure;

FIG. 7 shows a flowchart of a method for quantum computation according to an embodiment of the present disclosure;

FIG. 8 shows a schematic diagram of an apparatus for simulating a quantum circuit according to an embodiment of the present disclosure;

FIG. 9 shows a schematic diagram of an apparatus for simulating a quantum circuit according to another embodiment of the present disclosure;

FIG. 10 shows a schematic diagram of an apparatus for quantum computation according to an embodiment of the present disclosure; and

FIG. 11 shows a structure block diagram of an exemplary electronic device capable of being used to implement an embodiment of the present disclosure.

### DETAILED DESCRIPTION

Embodiments of the present disclosure are described below with reference to accompanying drawings, which include various details of the embodiments of the present disclosure to facilitate understanding and should be considered as exemplary only. Accordingly, those of ordinarily skilled in the art should recognize that various changes and modifications of the embodiments described herein can be made without departing from the scope of the present disclosure. Similarly, descriptions of well-known functions and constructions are omitted from the following description for clarity and conciseness.

In the present disclosure, unless otherwise specified, the use of terms “first”, “second”, etc. for describing various elements is not intended to limit the positional relationship, timing relationship or importance relationship of these elements, and such terms are only used to distinguish one element from another. In some examples, a first element and a second element may refer to the same instance of the elements, while in some cases they may refer to different instances based on the description of the context.

Terms used in the description of the various examples in the present disclosure are for the purpose of describing particular examples only and are not intended for limiting. Unless the context clearly dictates otherwise, if the quantity of an element is not expressly limited, the element may be one or more. Furthermore, as used in the present disclosure, the term “and/or” covers any one and all possible combinations of listed items.

A quantum system mentioned in all the embodiments of the present disclosure is a part of hardware of a quantum computer, which may be any physical system that satisfies the principle of quantum mechanics and thus can be applied to the quantum computer. For example, the above quantum system includes but is not limited to optical quantum systems, nuclear magnetic resonance (NMR) systems, optical resonance systems, ion traps, superconductivity and other quantum systems. After the quantum system receives a driving pulse input from the outside world, the quantum system will evolve from an initial state thereof to a final state according to the principle of quantum mechanics, and a final quantum computation result may be obtained by measuring the final state of the quantum system. The above quantum system may also be a physical system simulated by a classical computer according to the principle of quantum mechanics.

Hereinafter, embodiments of the present disclosure will be described in detail with reference to the accompanying drawings.

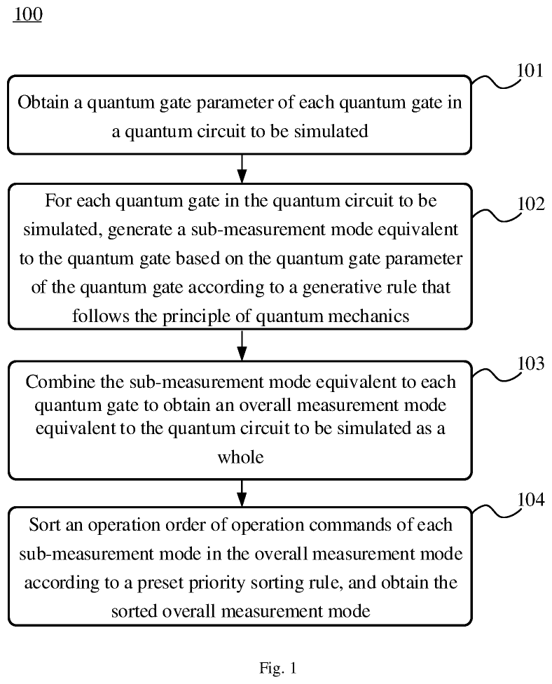

According to an aspect of the present disclosure, the present disclosure first provides a method for simulating a quantum circuit. FIG. 1 shows a flowchart of a method 100 for simulating a quantum circuit according to an embodiment of the present disclosure. As shown in FIG. 1, the method 100 includes:

step 101, quantum gate parameters of each quantum gate in a quantum circuit to be simulated are obtained;

step 102, for each quantum gate in the quantum circuit to be simulated, a sub-measurement mode equivalent to the quantum gate is generated based on the quantum gate parameters of the quantum gate according to a generative rule that follows the principle of quantum mechanics, and the sub-measurement mode includes a plurality of operation commands;

step 103, the sub-measurement mode equivalent to each quantum gate is combined to obtain an overall measurement mode equivalent to the quantum circuit to be simulated as a whole; and

step 104, an operation order of the operation commands of each sub-measurement mode in the overall measurement mode is sorted according to a preset priority sorting rule, and the sorted overall measurement mode is obtained as a simulation result of the quantum circuit to be simulated.

An embodiment of the present disclosure provides the novel method for simulating the quantum circuit. The method transforms the quantum circuit for quantum computation into an equivalent measurement mode according to a one-way quantum computer computation model. The quantum system of the quantum computer is operated according to the above equivalent measurement mode so as to make the quantum system evolve according to the equivalent quantum circuit. Therefore, in the case of using the classical computer for quantum computation, the method of the present embodiment is used to avoid direct simulation computation on the quantum circuit for quantum computation. Instead, the function of the equivalent quantum circuit can be achieved by performing corresponding operations on qubits in the quantum system, so that a simulation operation amount of the classical computer is greatly reduced. In addition, the method also sorts the operation commands of the measurement mode according to the preset priority sorting rule, and optimizes the operation order of the plurality of operation commands, thereby ensuring accuracy of operation on the qubits by the operation commands of the measurement mode.

In the prior art, quantum evolution in quantum computation is mainly realized in a mode of building a quantum circuit. Then a classical computer is used to directly simulate and compute the quantum circuit. Since the length of a column vector describing a quantum state increases exponentially with the corresponding number of bits, it is difficult for the classical computer to simulate large-scale quantum circuits with a plurality of bits. Existing quantum circuit simulators can only simulate computations with dozens of qubits at best. Therefore, there is an urgent need for a method that can replace quantum circuits for quantum computation at present.

Methods described in this section are not necessarily methods that have been previously conceived or employed. Unless otherwise indicated, it should not be assumed that any of the methods described in this section qualify as prior art merely by virtue of their inclusion in this section. Similarly, unless otherwise indicated, the problems raised in this section should not be considered to be recognized in any prior art.

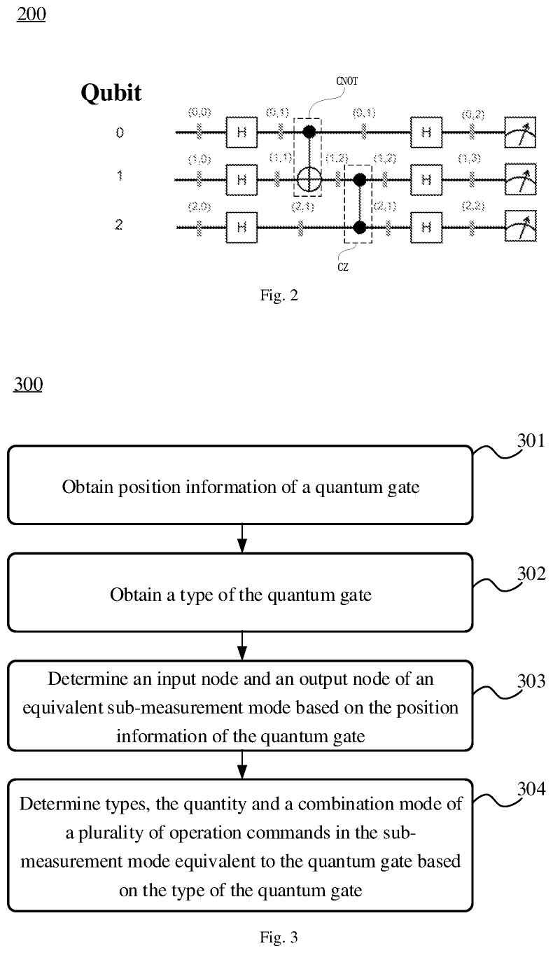

In step 101, the quantum circuit may be obtained by compiling expected quantum computation in advance. A structure of the quantum circuit is shown in FIG. 2. And FIG. 2 shows a schematic diagram of a quantum circuit 200 according to an embodiment of the present disclosure. As shown in FIG. 2, the quantum circuit 200 includes a plurality of qubits and a plurality of quantum gates operating the plurality of qubits. The types of these quantum gates include but are not limited to a Hadamard gate (represented by H in FIG. 2), a controlled Z gate (represented by CZ in FIG. 2), a controlled NOT gate (represented by CNOT in FIG. 2), etc. A quantum measurement is disposed at the end of a quantum circuit wire of each qubit and configured to measure an expected value of that qubit by using a measurement device. In step 101, parameters of each quantum gate are first obtained, and the above quantum gate parameters include but are not limited to parameters such as the type of the quantum gate and position information of the quantum gate in the quantum circuit. The quantum gate parameters are an reference for the subsequent transformation of the quantum gates into equivalent sub-measurement modes. In addition, the above quantum circuit further includes a plurality of nodes between adjacent quantum gates, between the quantum gates and the quantum measurements, and between the quantum gates and initial state qubits. To facilitate subsequent use of these nodes in the measurement mode, these nodes may be pre-marked in the quantum circuit.

In step 102, for each quantum gate in the quantum circuit to be simulated, the sub-measurement mode equivalent to the quantum gate is generated based on the quantum gate parameters in step 101, and the generation process will follow the principle of quantum mechanics. Specifically, in the one-way quantum computer computation model (1WQC), the quantum gates may be transformed into the equivalent measurement modes. The specific principle is: when some bits of a quantum entanglement state in the quantum system are measured, a quantum system that is not measured will achieve the corresponding evolution, so the required quantum evolution can be achieved by controlling a measurement manner. Mathematically, the above control over the measurement manner may be described by using the measurement modes. Each measurement mode obtained in step 102 consists of four parts: a computation space, an input node, an output node, and operation commands. The measurement mode can be expressed as follows:

Measurement mode=(computation space, input node, output node, operation commands).

In the above expression, the “computation space” is a set of all nodes involved in the 1WQC models, the “input node” is a node that obtains an initial quantum state as input, the “output node” is a node that outputs the quantum state or a classical measurement result, and the “operation commands” means instructions to perform corresponding operations on the nodes in the computation space in the measurement mode. It should be noted here that qubits in a quantum circuit model and the qubits in the 1WQC model are not the same. In the quantum circuit model, the qubits refer to qubits that have an initial quantum state and will subsequently accept quantum gate operations as shown in FIG. 2, while in the 1WQC model, the qubits will correspond to the nodes as shown in FIG. 2. Therefore, the above “operation commands” to operate on the input and/or output of the nodes may actually be understood as operations on the qubits in the 1WQC model.

As described above, step 102 generates one equivalent sub-measurement mode based on each quantum gate. In step 103, a plurality of sub-measurement modes generated in step 102 are combined to obtain the overall measurement mode equivalent to the quantum circuit to be simulated as a whole. Specifically, the above sub-measurement modes may be connected in series according to an execution order of the quantum gates or an order of each quantum gate in the quantum circuit. For example, the sub-measurement mode corresponding to a first quantum gate in the quantum circuit is located at a front end of the overall measurement mode, followed by the sub-measurement mode corresponding to a second quantum gate and the sub-measurement mode corresponding to a third quantum gate.

The plurality of operation commands in the overall measurement mode obtained in step 103 are arranged according to an initial order when each sub-measurement mode is generated, and the plurality of operation commands among the sub-measurement modes are not sorted. In step 104, the operation order of the plurality of operation commands in the overall measurement mode is arranged according to the operation priority of each operation command. For example, the plurality of operation commands may be prioritized according to their types, that is, it may be specified that the operation commands of type A are executed first, and the operation commands of type B are executed after all the operation commands of type A are executed. For another example, the operation commands of the same type may also be sorted by priority, especially in the case that there is a dependency relationship between two operation commands of the same type (for example, when an operation command b is executed, an operation result of an operation command a needs to be applied), the depended operation command (i.e., the operation command a) may be executed preferentially. A sorting method of the operation commands will be described in detail below, and will not be repeated here. Step 104 optimizes the operation order of the plurality of operation commands in the overall measurement mode, thereby improving the accuracy and computational efficiency of operation on the qubits by the operation commands

FIG. 3 shows a flowchart of a method 300 for generating a sub-measurement mode equivalent to a quantum gate according to an embodiment of the present disclosure. As shown in FIG. 3, the method 300 includes:

step 301, position information of each quantum gate is obtained;

step 302, a type of the quantum gate is obtained;

step 303, the input node and the output node of the equivalent sub-measurement mode are determined based on the position information of the quantum gate; and

step 304, types, the quantity and a combination mode of the plurality of operation commands in the sub-measurement mode equivalent to the quantum gate are determined based on the type of the quantum gate.

As described above, the quantum circuit 200 also includes a plurality of nodes that may be configured to represent the position information for each quantum gate. To facilitate subsequent use of these nodes in the measurement mode, these nodes may be pre-marked in the quantum circuit. Continuing to refer to FIG. 2, each node is marked as a binary array. A first element of each binary array is the current qubit. A second element starts from zero, and according to an order of action of the quantum gates (an order from left to right in FIG. 2), it increases by 1 every time a quantum gate passes through. The second element of each binary array does not add 1 when passing through a control bit of the controlled NOT gate, and does not add 1 when passing through a control bit and a target bit of the controlled Z gate. Each node in the quantum circuit may be marked by using the above rule. In step 301, adjacent nodes around each quantum gate may be obtained respectively as the position information of the quantum gate.

In step 302, continuing to obtain the type of each quantum gate, and the types of these quantum gates include but are not limited to the Hadamard gate, the controlled Z gate, the controlled NOT gate, etc. as shown in FIG. 2. In other embodiments of the present disclosure, the types of the quantum gates may also include other logic gates that satisfy the principle of quantum mechanics (for example, Pauli X gate, Pauli Y gate, Pauli Z gate, Toffoli gate, etc.), which will not be described here one by one.

In step 303, the input node and output node of the sub-measurement mode equivalent to the quantum gate are determined based on the position information obtained in step 301. In step 304, the types, the quantity, and the combination mode of the plurality of operation commands in the equivalent sub-measurement mode are determined based on the type of the quantum gate obtained in step 302. Taking the Hadamard gate shown in FIG. 2 (hereinafter referred to as the H gate) as an example, a mathematical expression of the quantum gate is:

$$H = [ \begin{matrix}1 & 1 \\ 1 & - 1\end{matrix} ] / \sqrt{2} \qquad ( 1 )$$

Therefore, according to the principle of quantum mechanics, the sub-measurement mode equivalent to this type of quantum gate may be expressed as:

H=({i,j},{i},{j},Xⱼ^{S}^{ᵢ}Mᵢ⁰EᵢⱼNⱼ) (2)

In the above formula (2), i represents the input node and j represents the output node. And the sub-measurement mode also includes 4 types of operation commands, which are a state preparation command Nⱼ, an entanglement command Eᵢⱼ, a measurement command Mᵢ⁰, and an operator correction command Xⱼ^{s}^{ᵢ}, where sᵢ in Xⱼ^{s}^{ᵢ} represents a measurement result after the measurement command is executed on the input node i. According to the principle of quantum mechanics, the operation commands need to be executed from right to left. For example, the state preparation command is first executed to prepare an added state on the output node j; then the entanglement command is executed to control a Z operator on nodes i and j; then the measurement command is executed, the input node I is measured, and a measurement angle is 0; and finally the operator correction command is executed, and if the measurement result of node i is sᵢ=1, then a Pauli X operator is applied to the qubits on node j, otherwise, the Pauli X operator is not applied.

After the input node and output node of the sub-measurement mode are determined, these two nodes may be brought into formula (2) to obtain a final expression of the sub-measurement mode. Taking a first H gate shown in the upper left of FIG. 2 as an example, the input node is (0, 0) and the output node is (0, 1), and the above two nodes are brought into formula (2) to obtain the final expression of the equivalent sub-measurement mode, namely:

H=({(0,0),(0,1)},{(0,0)},{(0,1)}, X_{(0,1)}^{s}^{_{(0,0)}}M_{(0,0)}⁰E_{(0,0)(0,1)}N_{(0,1)}) (3)

After passing all the operation commands according to an order in formula (3), a quantum state of the quantum system at the output node is equivalent to a quantum state H|ψ [symbol] after the H gate is applied on the quantum state |ψ [symbol] on the input node.

Similarly, the equivalent sub-measurement mode with the type of the controlled Z gate is:

CZ=({i,j},{i,j},{i,j},Eᵢⱼ) (4)

Continuing to refer to the Z gate shown in FIG. 2, according to node marks in a quantum circuit diagram, the input node i is (1, 2) and the output node j is (2, 1), then the final generated sub-measurement mode is expressed as:

CZ=({(1,2),(2,1)},{(1,2),(2,1)},{(1,2),(2,1)},E₍1,2)(2,1)) (5)

Similarly, the equivalent sub-measurement mode with the type of the controlled NOT gate is:

CNOT=({i,j,k,l},{i,j},{i,l},Zₗ^{s}^{ⱼ}Zᵢ^{s}^{ⱼ}Xₗ^{s}^{ₖ}Mₖ⁰Mⱼ⁰EₖₗEⱼₖEᵢₖNₖNₗ) (6)

Different from the above H gate and the controlled Z gate, the controlled NOT gate includes two output nodes j and 1, and additionally includes an auxiliary node k. A first element of binary array marks of auxiliary nodes (that is, nodes other than the input node and the output node in the computation space) is the same as the input node or the output node, and a second element is uniformly valued between values of the input node and the output node according to the quantity of the auxiliary nodes.

Continuing to refer to the controlled NOT gate shown in FIG. 2, according to the node marks in the quantum circuit diagram, the input node i is (0, 1), the first output node j is (1, 1), and the second output node 1 is (1, 2), the auxiliary node k is (1, 1.5), and then the final generated sub-measurement mode is expressed as:

$$( \begin{matrix}\{ ( 0 , 1 ) , ( 1 , 1 ) , ( 1 , 1.5 ) , ( 1 , 2 ) \} , \\ \{ ( 0 , 1 ) , ( 1 , 1 ) \} , \\ \{ ( 0 , 1 ) , ( 1 , 2 ) \} , \\ {Z}_{( 1 , 2 )}^{{s}_{( 1 , 1 )}} {Z}_{( 0 , 1 )}^{{s}_{( 1 , 1 )}} {X}_{( 1 , 2 )}^{{s}_{( 1 , 1.5 )}} {M}_{( 1 , 1.5 )}^{0} {M}_{( 1 , 1 )}^{0} {E}_{( 1 , 1.5 ) ( 1 , 2 )} {E}_{( 1 , 1 ) ( 1 , 1.5 )} {E}_{( 0 , 1 ) ( 1 , 1.5 )} {N}_{( 1 , 1.5 )} {N}_{( 1 , 2 )}\end{matrix} ) \qquad ( 7 )$$

In some embodiments of the present disclosure, after combining the plurality of sub-measurement modes to obtain the overall measurement mode, the plurality of operation commands in the overall measurement mode are prioritized. Generally speaking, the prioritizing includes two steps, first sorting the operation commands according to the types of the operation commands, and then executing the ordering of the plurality of operation commands of the same type for the operation commands of the same type.

In some embodiments, the types of the plurality of operation commands may include state preparation commands N, entanglement commands E, measurement commands M, and operator correction commands X and Z. According to the preset sorting rule, sorting the operation order of the operation commands of each sub-measurement mode in the overall measurement mode also includes: the operation order of the plurality of operation commands is sorted according to an order in which the state preparation commands, the entanglement commands, the measurement commands and the operator correction commands are executed in sequence.

Specifically, after the operation commands of the overall measurement mode are obtained, the order of the operation commands may be “normalized” according to an exchange rule that conforms to the principle of quantum mechanics. For example, through the exchange between two adjacent operation commands, all state preparation commands are at the forefront end of the operation order, followed by all the entanglement commands, again all the measurement commands, and finally all the operator correction commands. In the case where a superscript is omitted, the operation commands of the overall measurement mode obtained after the “normalization” operation will be in a form of {X . . . XZ . . . ZM . . ME . . . EN . . . N}.

The reason for the above sorting is that in the theory of the 1WQC model, a state preparation operation and an entanglement operation need to be performed on the qubits under the model first, so as to create a resource state that may measure the qubits. Therefore, it may be understood that the state preparation commands and the entanglement commands should precede the measurement commands. In addition, referring to the above formulas (2) and (6), it is understood that the operation manner of the operator correction commands in the sub-measurement mode may depend on the measurement result of the measurement commands. Therefore, the measurement commands need to be set before the operator correction commands.

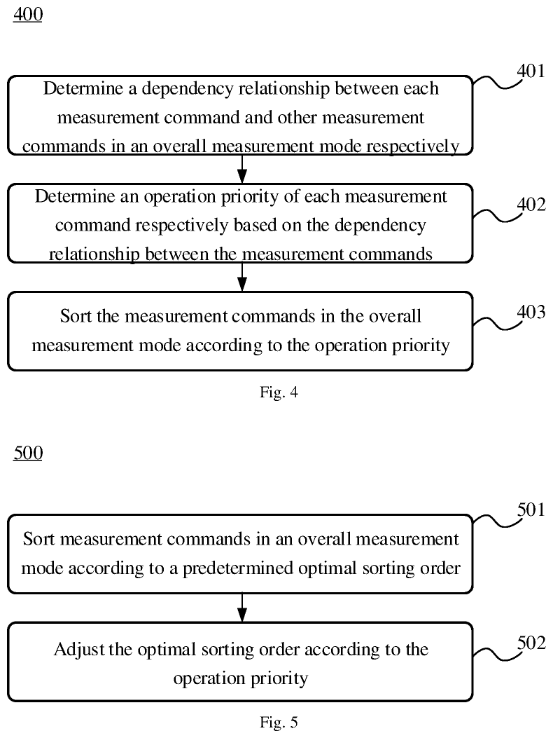

In some embodiments of the present disclosure, the plurality of measurement commands may also be sorted independently. FIG. 4 shows a flowchart of a method 400 for sorting a plurality of measurement commands in an overall measurement mode according to an embodiment of the present disclosure, and as shown in FIG. 4, the method 400 includes the following steps:

step 401, a dependency relationship between each measurement command and other measurement commands in the overall measurement mode is determined respectively;

step 402, the operation priority of each measurement command is determined based on the dependency relationship between the measurement commands; and

step 403, the measurement commands in the overall measurement mode are sorted according to the operation priority.

After completing the above “normalization” sorting of the operation commands, each obtained measurement command will be expressed as: [Mⱼ^{α}^{_{0]}}ₜ^{r}, where j is a mark of a node to be measured, and α₀ is the measurement angle during measurement, and r and t are other nodes that have a dependency relationship with the node j, respectively. For example, the set of r may have three nodes that have the dependency relationship with j, that is, r={u, v, w}, the set of t may have two nodes that have the dependency relationship with j, that is, t={x, y}, then the measurement command [Mⱼ^{α]}ₜ^{r} means to measure the node j, and the measurement angle α is:

α=(−1)^{s}^{ᵤ}^{+s}^{ᵥ}^{+s}^{_{w}}·α₀+(sₓ+s_{y})·π (8)

where α₀ is a preset initial angle, and sₖ represents the measurement result of the node k. It may be seen from the above formula that when the node j is measured, the measurement angle α depends on measurement results of nodes u, v, w, x, and y. Therefore, it may be understood that before measuring j, it is necessary to measure the nodes u, v, w, x, and y and obtain the measurement results.

If there is no interdependency relationship between two measurement commands, the measurement order may be exchanged arbitrarily, while the measurement commands with the interdependency relationship must perform the measurement of the depended nodes first, so as to ensure the correct execution of the measurement commands. According to this principle, in step 402, the operation priority of each measurement command may be determined respectively based on the dependency relationship between the measurement commands. Generally speaking, the depended measurement commands have a higher operation priority than a measurement command that depends on the command.

In step 403, according to the operation priority obtained in step 402, the measurement commands in the overall measurement mode are sorted, so as to ensure that the measurement commands with high dependencies are executed first, and corresponding measurement results are obtained, so that a computation basis for the measurement angle α is provided for subsequent measurement operation.

FIG. 5 shows a flowchart of a method 500 for sorting measurement commands according to an operation priority according to an embodiment of the present disclosure, and as shown in FIG. 5, the method 500 includes:

step 501, the measurement commands in the overall measurement mode are sorted according to a predetermined optimal sorting order; and

step 502, the optimal sorting order is adjusted according to the operation priority.

In step 501, the optimal sorting order refers to a sorting order that theoretically may achieve the smallest amount of computation in the execution process of the measurement commands. The optimal sorting order may be generated according to the following rule: marks of measurement nodes of every two measurement commands are compared, specifically, the first elements of the marks are preferentially compared, the node with the smaller number is ranked first, and the first elements of the marks of two nodes are the same, the second elements are compared, and the node with the smaller number is ranked first.

In step 502, the optimal sorting order in step 501 may be adjusted based on the operation priority obtained in step 402 of the method 400. Specifically, the operation order of two or more measurement commands that violate the operation priority order in the optimal sorting order may be exchanged, so that each measurement command satisfies the operation priority order.

The method of the embodiment first determines an optimal sorting order, which is the measurement order that minimizes the computation amount of the computer, the operation order of the measurement commands is adjusted based on the optimal sorting order, and the computation amount of the computer for simulating quantum computation can be reduced to a certain extent.

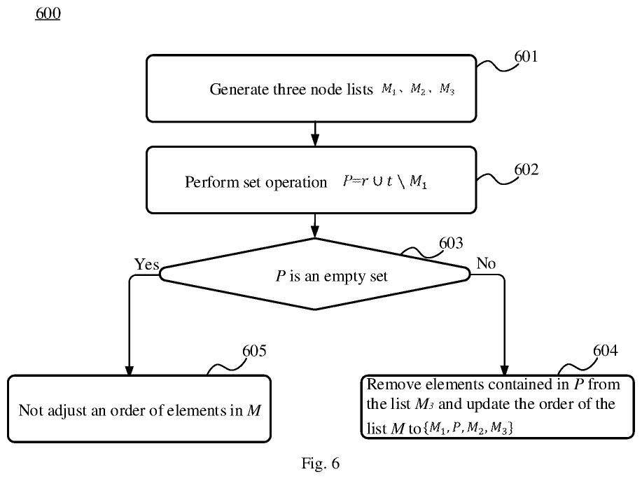

FIG. 6 shows a flowchart for implementing the methods shown in FIG. 4 and FIG. 5 by using a computer program according to an embodiment of the present disclosure, wherein, a list M represents a set of measurement nodes arranged in the optimal sorting order, which includes m elements (that is, m measurement nodes). The method 600 includes:

for each value in {1,, . . . ,m} of j, executing:

step 601, three node lists M₁, M₂, M₃ are generated, where M₁ contains 1st to <j−1>th elements in M, M₂ is a <j>th element in M, and M₃ contains <j+1>th to <m>th elements in M;

step 602, set operation is performed;

P=r∪t\M₁ (9)

where r and t represent a first node set and a second node set that have a dependency relationship with the measurement commands of node j, r∪t represents the union of sets r and t, and “\M₁” represents the removal of elements in set M₁, where P is an ordered list in which the elements are preferably sorted according to the optimal sorting order.

step 603, whether P is an empty set or not is judged;

step 604, if a judgment result of step 603 is “No”, then the elements contained in P are removed from the list M₃ and the order of the list M is updated to {M₁,P,M₂,M₃}; and

step 605, if the judgment result of step 603 is “Yes”, the order of the elements in M is not adjusted.

Each value in {1,2, . . . ,m} is taken by j in sequence, and the above step 601 to step 604 are repeatedly executed, so as to finish adjustment of the order of all the elements in M.

The method of the embodiment adjusts the position of each element in M one by one from element 1 to element m. It is understood that the above M₁ represents the first j elements whose order has been adjusted in M, and M₂ represents the <j>th element currently undergoing adjustment, while M₃ represents unadjusted elements. In step 602, the set P obtained according to the formula is the nodes that have a dependency relationship with the measurement commands of node j and have not been adjusted in order. Therefore, according to the above operation priority principle, the elements in P should be placed before M₂, thus obtaining the above updated order represented as {M₁,P,M₂,M₃}.

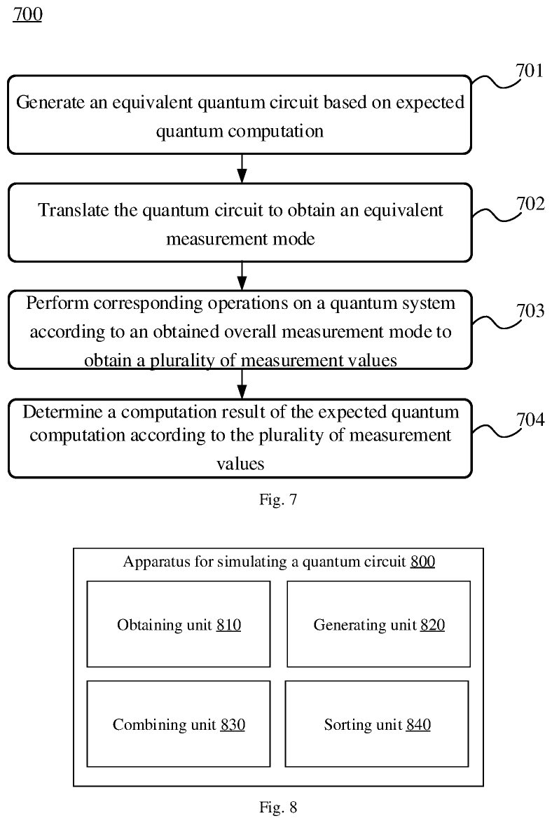

According to another aspect of the present disclosure, a method for quantum computation is also provided. FIG. 7 shows a flowchart of a method 700 for quantum computation according to an embodiment of the present disclosure. As shown in FIG. 7, the method 700 includes:

step 701, an equivalent quantum circuit is generated based on expected quantum computation;

step 702, the quantum circuit is translated to obtain an equivalent measurement mode;

step 703, corresponding operations are performed on a quantum system according to an obtained overall measurement mode to obtain a plurality of measurement values; and

step 704, a computation result of the expected quantum computation is determined according to the plurality of measurement values.

In step 702, the method 100 shown in FIG. 1 is used to translate and simulate the equivalent quantum circuit generated in step 701 to obtain the overall measurement mode, and specific steps refer to the description of FIG. 1, which will not be repeated here. In step 703, corresponding operations are performed on the quantum system according to the obtained overall measurement mode. As can be seen from the above, the overall measurement mode includes a plurality of measurement commands, and each measurement command represents a measurement operation for nodes in the quantum circuit (or, qubits under a 1WQC model). Each measurement operation will obtain a measurement value of one qubit under the 1WQC model. In the subsequent step 704, the computation result of the expected quantum computation may be determined according to the plurality of measurement values obtained in step 703.

The method for quantum computation in the embodiment can avoid direct simulation for the quantum circuit for quantum computation, but can achieve the function equivalent to the quantum circuit by simulating the equivalent measurement mode, thereby greatly reducing a simulation operation amount of a classical computer.

According to another aspect of the present disclosure, an apparatus for simulating a quantum circuit is also provided. FIG. 8 shows a schematic diagram of an apparatus 800 for simulating a quantum circuit according to an embodiment of the present disclosure. As shown in FIG. 8, the apparatus 800 includes: an obtaining unit 810, configured to obtain quantum gate parameters of each quantum gate in a quantum circuit to be simulated; a generating unit 820, configured to, for each quantum gate in the quantum circuit to be simulated, generate a sub-measurement mode equivalent to the quantum gate based on the quantum gate parameters of the quantum gate, the sub-measurement mode including at least one operation command; a combining unit 830, configured to combine the sub-measurement mode equivalent to each quantum gate to obtain an overall measurement mode equivalent to the quantum circuit to be simulated as a whole; and a sorting unit 840, configured to sort the operation command of each sub-measurement mode in the overall measurement mode according to a preset priority sorting rule, and obtain the sorted overall measurement mode as a simulation result of the quantum circuit to be simulated.

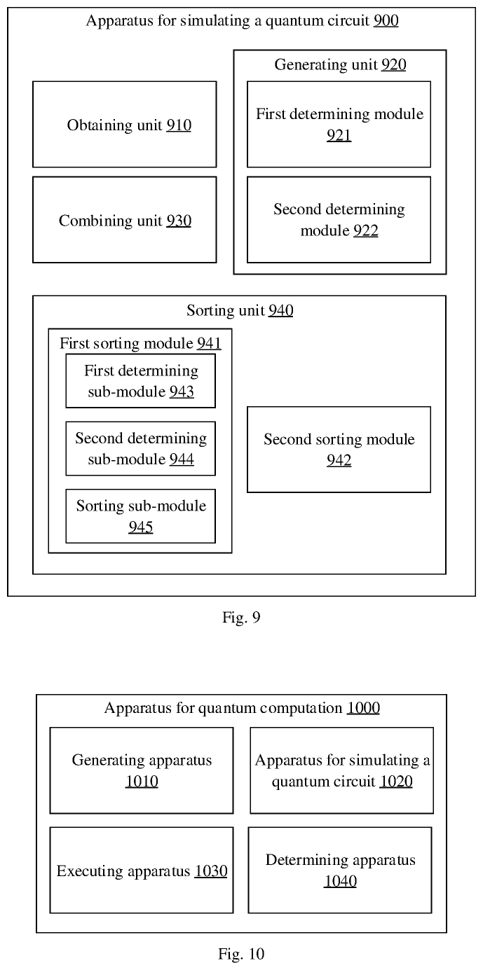

FIG. 9 shows a schematic diagram of an apparatus 900 for simulating a quantum circuit according to another embodiment of the present disclosure. As shown in FIG. 9, an obtaining unit 910 obtains quantum gate parameters including a type of each quantum gate and position information of the quantum gate in a quantum circuit to be simulated. As further shown in FIG. 9, a generating unit 920 includes: a first determining module 921 and a second determining module 922. The first determining module 921 is configured to determine types, the quantity, and a combination mode of a plurality of operation commands in the sub-measurement mode equivalent to the quantum gate based on the type of the quantum gate. The second determining module 922 is configured to determine an input node and an output node of the equivalent sub-measurement mode based on the position information of the quantum gate.

In some embodiments, the sorting unit 940 includes: a first sorting module 941, configured to individually sort a plurality of measurement commands according to an operation priority of each measurement command in the overall measurement mode.

The first sorting module 941 includes: a first determining sub-module 943, configured to determine a dependency relationship between each measurement command and other measurement commands in the overall measurement mode respectively; a second determining sub-module 944, configured to determine the operation priority of each measurement command based on the dependency relationship between the measurement commands; and a sorting sub-module 945, configured to sort the measurement commands in the overall measurement mode according to the operation priority.

In some embodiments, the sorting sub-module 945 is also configured to: sort the measurement commands in the overall measurement mode according to a predetermined optimal sorting order; and adjust the optimal sorting order according to the operation priority.

In some embodiments, the types of the plurality of operation commands further include a state preparation command, an entanglement command, and an operator correction command, wherein the sorting unit 940 further includes: a second sorting module 942, configured to sort an operation order of the plurality of operation commands according to an order in which the state preparation command, the entanglement command, a measurement command and the operator correction command are sequentially executed.

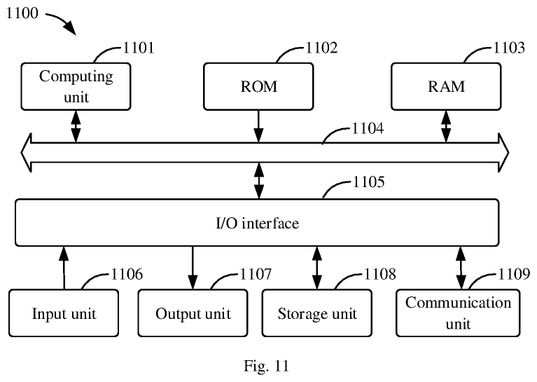

According to another aspect of the present disclosure, an apparatus for quantum computation is also provided, and FIG. 10 shows a schematic diagram of an apparatus 1000 for quantum computation according to an embodiment of the present disclosure. As shown in FIG. 10, the apparatus 1000 includes: a generating apparatus 1010, configured to generate an equivalent quantum circuit based on expected quantum computation; an apparatus 1020 for simulating the quantum circuit, the apparatus 1020 being the apparatuses 800 and 900 shown in FIG. 8 and FIG. 9; an executing apparatus 1030, configured to perform corresponding operations on a quantum system according to an obtained overall measurement mode to obtain a plurality of measurement values; and a determining apparatus 1040, configured to determine a computation result of the expected quantum computation according to the plurality of measurement values.

It should be understood that each unit of the apparatus 800 shown in FIG. 8 may correspond to each step in the method 100 described with reference to FIG. 1, and each module/apparatus of the apparatus 1000 shown in FIG. 10 may correspond to each step in the method 700 described with reference to FIG. 7. Thus, the operations, features and advantages described above for the method 100 are equally applicable to the apparatus 800 and the included units thereof, and the operations, features and advantages described above for the method 700 are also applicable to the apparatus 1000 and the included modules/apparatuses thereof. For the sake of brevity, certain operations, features, and advantages are not repeated here.

According to embodiments of the present disclosure, an electronic device, a readable storage medium, and a computer program product are also provided.

Referring to FIG. 11, a structural block diagram of an electronic device 1100 that may serve as a server or a client of the present disclosure will be described, which is an example of a hardware device that may be applied to various aspects of the present disclosure. The electronic device is intended to represent various forms of digital electronic computer devices, such as laptop computers, desktop computers, workstations, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are by way of example only, and are not intended to limit implementations of the present disclosure described and/or claimed herein.

As shown in FIG. 11, the device 1100 includes a computing unit 1101, which may perform various appropriate actions and processes according to a computer program stored in a read only memory (ROM) 1102 or a computer program loaded into a random access memory (RAM) 1103 from a storage unit 1108. In the RAM 1103, various programs and data necessary for the operation of the device 1100 may also be stored. The computing unit 1101, the ROM 1102, and the RAM 1103 are connected to one another through a bus 1104. An input/output (I/O) interface 1105 is also connected to the bus 1104.

Various components in the device 1100 are connected to the I/O interface 1105, including: an input unit 1106, an output unit 1107, the storage unit 1108, and a communication unit 1109. The input unit 1106 may be any type of device capable of inputting information to the device 1100. The input unit 1106 may receive input numerical or character information, and generate key signal input related to user settings and/or function control of the electronic device, and may include, but is not limited to, a mouse, a keyboard, a touch screen, a trackpad, a trackball, a joystick, a microphone and/or a remote control. The output unit 1107 may be any type of device capable of presenting information, and may include, but is not limited to, a display, speakers, video/audio output terminals, vibrators, and/or printers. The storage unit 1108 may include, but is not limited to, magnetic disks and compact discs. The communication unit 1109 allows the device 1100 to exchange information/data with other devices through a computer network such as the Internet and/or various telecommunication networks, and may include, but is not limited to, modems, network cards, infrared communication devices, wireless communication transceivers and/or chips groups, such as Bluetooth™ devices, 802.11 devices, WiFi devices, WiMax devices, cellular communication devices and/or the like.

The computing unit 1101 may be various general purpose and/or special purpose processing components with processing and computing capabilities. Some examples of the computing unit 1101 include, but are not limited to, central processing units (CPUs), graphics processing units (GPUs), various specialized artificial intelligence (AI) computing chips, various computing units that run machine learning model algorithms, digital signal processors (DSPs), and any suitable processor, controller, microcontroller, etc. The computing unit 1101 performs the various methods and processes described above, such as the above method for simulating the quantum circuit or the above method for quantum computation. For example, in some embodiments, the method for simulating the quantum circuit and the method for quantum computation may be implemented as a computer software program tangibly embodied on a machine-readable medium, such as the storage unit 1108. In some embodiments, part or all of the computer program may be loaded and/or installed on the device 1100 via the ROM 1102 and/or the communication unit 1109. When the computer program is loaded to the RAM 1103 and executed by the computing unit 1101, one or more steps for quantum computation described above may be performed. Alternatively, in other embodiments, the computing unit 1101 may be configured to perform the method for simulating the quantum circuit and the method for quantum computation by any other suitable means (for example, by means of firmware).

Various implementations of the systems and technologies described above in this paper may be implemented in a digital electronic circuit system, an integrated circuit system, a field programmable gate array (FPGA), an application specific integrated circuit (ASIC), an application specific standard part (ASSP), a system on chip (SOC), a load programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program codes for implementing the methods of the present disclosure may be written in any combination of one or more programming languages. These program codes may be provided to processors or controllers of a general-purpose computer, a special-purpose computer or other programmable data processing apparatuses, so that when executed by the processors or controllers, the program codes enable the functions/operations specified in the flow diagrams and/or block diagrams to be implemented. The program codes may be executed completely on a machine, partially on the machine, partially on the machine and partially on a remote machine as a separate software package, or completely on the remote machine or server.

In the context of the present disclosure, a machine readable medium may be a tangible medium that may contain or store a program for use by or in connection with an instruction execution system, apparatus or device. The machine readable medium may be a machine readable signal medium or a machine readable storage medium. The machine readable medium may include but not limited to an electronic, magnetic, optical, electromagnetic, infrared, or semiconductor system, apparatus or device, or any suitable combination of the above contents. More specific examples of the machine readable storage medium will include electrical connections based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and techniques described herein may be implemented on a computer, and the computer has: a display apparatus for displaying information to the users (e.g., a CRT (cathode ray tube) or LCD (liquid crystal display) monitor); and a keyboard and a pointing device (e.g., a mouse or trackball), through which the users may provide input to the computer. Other types of apparatuses may further be used to provide interactions with users; for example, feedback provided to the users may be any form of sensory feedback (e.g., visual feedback, auditory feedback, or tactile feedback); an input from the users may be received in any form (including acoustic input, voice input or tactile input).

The systems and techniques described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally remote from each other and usually interact through a communication network. The relationship of the client and the server arises by computer programs running on respective computers and having a client-server relationship to each other.

It should be understood that steps may be reordered, added or deleted using the various forms of flow shown above. For example, the steps described in the present disclosure may be executed in parallel, sequentially or in different orders, as long as desired results of a technical solution disclosed in the present disclosure may be achieved, and are not limited herein.

Although the embodiments or examples of the present disclosure have been described with reference to the accompanying drawings, it should be understood that the above methods, systems and devices are only exemplary embodiments or examples, and the scope of the present disclosure is not limited by these embodiments or examples, but only by the authorized claims and their equivalent scope. Various elements in the embodiments or examples may be omitted or replaced by their equivalent elements. In addition, the steps may be performed in an order different from that described in the present disclosure. Further, various elements in the embodiments or examples may be combined in various ways. It is important that as technology evolves, many of the elements described herein may be replaced by equivalent elements that appear after the present disclosure.

What is claimed is:

1. A method for operating a quantum computer, the quantum computer comprising a quantum circuit to be simulated, the quantum circuit comprising a plurality of quantum gates, the method comprising:
obtaining a quantum gate parameter of each quantum gate in the quantum circuit to be simulated;
for each quantum gate in the quantum circuit to be simulated,
generating a sub-measurement mode equivalent to the quantum gate based on the quantum gate parameter of the quantum gate, the sub-measurement mode comprising a plurality of operation commands;
combining the sub-measurement mode equivalent to each quantum gate to obtain an overall measurement mode equivalent to the quantum circuit to be simulated as a whole; and
sorting an operation order of the plurality of operation commands of each sub-measurement mode in the overall measurement mode according to a preset priority sorting rule, thereby obtaining a sorted overall measurement mode as a simulation result of the quantum circuit to be simulated.

2. The method of claim 1, wherein the quantum gate parameter comprises a type of the quantum gate, and wherein generating the sub-measurement mode equivalent to the quantum gate based on the quantum gate parameter of the quantum gate comprises:
determining a type, quantity, and combination mode of the plurality of operation commands in the sub-measurement mode equivalent to the quantum gate based on the type of the quantum gate.

3. The method of claim 2, wherein the quantum gate parameter further comprises position information of the quantum gate in the quantum circuit to be simulated, and the sub-measurement mode further comprises an input node and an output node, and wherein
generating the sub-measurement mode equivalent to the quantum gate based on the quantum gate parameter of the quantum gate further comprises:
determining the input node and the output node of the equivalent sub-measurement mode based on the position information of the quantum gate.

4. The method of claim 2, wherein the type of the plurality of operation commands comprises a measurement command, and wherein sorting the operation order of the operation commands of each sub-measurement mode in the overall measurement mode according to the preset priority sorting rule comprises:
individually sorting the plurality of measurement commands according to an operation priority of each measurement command in the overall measurement mode.

5. The method of claim 4, wherein individually sorting the plurality of measurement commands according to the operation priority of each measurement command in the overall measurement mode comprises:
determining a dependency relationship between each measurement command and other measurement commands in the overall measurement mode respectively;
determining the operation priority of each measurement command based on the dependency relationship between the various measurement commands; and
sorting the measurement commands in the overall measurement mode according to the operation priority.

6. The method of claim 5, wherein sorting the measurement commands in the overall measurement mode according to the operation priority further comprises:
sorting the measurement commands in the overall measurement mode according to a predetermined optimal sorting order; and
adjusting the optimal sorting order according to the operation priority.

7. The method of claim 2, wherein the type of the plurality of operation commands further comprises a state preparation command, an entanglement command, and an operator correction command; wherein sorting the operation order of the plurality of operation commands of each sub-measurement mode in the overall measurement mode according to the preset sorting rule further comprises:
sorting the operation order of the plurality of operation commands according to an order in which the state preparation command, the entanglement command, the measurement command, and the operator correction command are sequentially executed.

8. A method for quantum computation, comprising:
generating an equivalent quantum circuit based on expected quantum computation, thereby obtaining a quantum circuit to be simulated;
obtaining a quantum gate parameter of each quantum gate in the quantum circuit to be simulated;
for each quantum gate in the quantum circuit to be simulated,
generating a sub-measurement mode equivalent to the quantum gate based on the quantum gate parameter of the quantum gate, the sub-measurement mode comprising a plurality of operation commands;
combining the sub-measurement mode equivalent to each quantum gate to obtain an overall measurement mode equivalent to the quantum circuit to be simulated as a whole; and
sorting an operation order of the plurality of operation commands of each sub- measurement mode in the overall measurement mode according to a preset priority sorting rule, thereby obtaining a sorted overall measurement mode as a simulation result of the quantum circuit to be simulated;
performing corresponding operations on a quantum system according to an obtained overall measurement mode to obtain a plurality of measurement values; and
determining a computational result of the expected quantum computation according to the plurality of measurement values.

9. An electronic device, comprising:
one or more processors; and
a memory storing one or more programs configured to be executed by the one or more processors, the one or more programs including instructions for causing the electronic device to perform operations comprising: obtaining a quantum gate parameter of each quantum gate in a quantum circuit to be simulated;
for each quantum gate in the quantum circuit to be simulated, generating a sub-measurement mode equivalent to the quantum gate based on the quantum gate parameter of the quantum gate, the sub-measurement mode comprising a plurality of operation commands;
combining the sub-measurement mode equivalent to each quantum gate to obtain an overall measurement mode equivalent to the quantum circuit to be simulated as a whole; and
sorting an operation order of the plurality of operation commands of each sub- measurement mode in the overall measurement mode according to a preset priority sorting rule, thereby obtaining a sorted overall measurement mode as a simulation result of the quantum circuit to be simulated.

10. The electronic device of claim 9, wherein generating the sub-measurement mode equivalent to the quantum gate based on the quantum gate parameter of the quantum gate comprises:
determining a type, quantity, and combination mode of the plurality of operation commands in the sub-measurement mode equivalent to the quantum gate based on the type of the quantum gate.

11. The electronic device of claim 10, wherein the quantum gate parameter further comprises position information of the quantum gate in the quantum circuit to be simulated, and the sub-measurement mode further comprises an input node and an output node, and wherein
generating the sub-measurement mode equivalent to the quantum gate based on the quantum gate parameter of the quantum gate further comprises:
determining the input node and the output node of the equivalent sub-measurement mode based on the position information of the quantum gate.

12. The electronic device of claim 10, wherein the type of the plurality of operation commands comprises a measurement command, and wherein sorting the operation order of the operation commands of each sub-measurement mode in the overall measurement mode according to the preset priority sorting rule comprises:
individually sorting the plurality of measurement commands according to an operation priority of each measurement command in the overall measurement mode.

13. The electronic device of claim 12, wherein individually sorting the plurality of measurement commands according to the operation priority of each measurement command in the overall measurement mode comprises:
determining a dependency relationship between each measurement command and other measurement commands in the overall measurement mode respectively;
determining the operation priority of each measurement command based on the dependency relationship between the various measurement commands; and
sorting the measurement commands in the overall measurement mode according to the operation priority.

14. The electronic device of claim 13, wherein sorting the measurement commands in the overall measurement mode according to the operation priority further comprises:
sorting the measurement commands in the overall measurement mode according to a predetermined optimal sorting order; and
adjusting the optimal sorting order according to the operation priority.

15. The electronic device of claim 10, wherein the type of the plurality of operation commands further comprises a state preparation command, an entanglement command, and an operator correction command; wherein sorting the operation order of the plurality of operation commands of each sub-measurement mode in the overall measurement mode according to the preset sorting rule further comprises:
sorting the operation order of the plurality of operation commands according to an order in which the state preparation command, the entanglement command, the measurement command and the operator correction command are sequentially executed.
